(19) United States
(12) Patent Application Publication
(10) Pub. No.: US 2005/0098384 A1
(43) Pub. Date: May 12, 2005

(54) Structure automobile engine crankcase oil drain tap plug

(76) Inventor: Hsueh Chin Chang, Taichung City (TW)

Correspondence Address: Hsueh Chin Chang, P.O. Box 63-150, Taichung City, TW

(21) Appl. No.: 10/774,924

(22) Filed: Feb. 6, 2004

(30) Foreign Application Priority Data
Nov. 12, 2003 (TW) 092220007

(51) Int. Cl. F16C 3/14

(52) U.S. Cl. 184/1.5

(57) ABSTRACT

An improved structure automobile engine crankcase oil drain tap plug that provides for airtight thread fastening in oil drain holes, its top side having an embedded annular magnet that attracts and collects friction-generated metal particles suspended in engine crankcase oil and its internal section having a steel ball valve capable of a predetermined range of upward and downward travel, thereby enabling the downward release and drawing out of engine oil in the crankcase, with its lowermost extremity featuring a threaded sealing ring that ensures that engine crankcase oil does not leak.

### BACKGROUND OF THE INVENTION

1) Field of the Invention

The invention herein relates to automotive maintenance accessories, specifically an improved structure automobile engine crankcase oil drain tap plug.

2) Description of the Prior Art

An important task in current automotive vehicle maintenance concerns the automobile lubrication system, wherein the engine crankcase is emptied and the used oil drawn out is replaced with new oil. For a long time, the task of emptying all brands of automobile engine crankcases was only facilitated by a hexagonal bolt rotationally tightened in the oil drain hole in the bottom section of an engine crankcase or a screwed-in oil drain hole tap plug 1 (as shown in FIG. 1) equipped with a valve cock 2 disposed perpendicularly through the diameter from one side that was rotated so many degrees to indirectly open or close a lengthwise passage 3; since lifting equipment capable of raising the automobile is required during maintenance, followed by the placement of an oil pan (not shown in the drawings) on the floor under the engine crankcase to contain the used oil discharged from the said engine crankcase, when the said hexagonal bolt was removed from the oil drain hole or the cock valve 2 of the oil drain hole tap plug was rotated open, the discharged used oil surged forth, often contaminating the floor and splattering everywhere; additionally, since the engine crankcase oil is utilized to lubricate moving parts but metal particles produced by frictional wear are unavoidable in the process, these metal particles mixed in with the oil resulted in varying degrees of damage to all systems, and from an environmental standpoint, the conventional structure lacks effective countermeasures, especially at the rotatable cock valve 2 horizontally disposed in the said oil drain hole tap plug 1 because metal particles carried in the discharged used oil easily accumulate in the lateral clearances 2a of the cock valve 2 whenever it is rotated to open the oil passage, resulting in wear and consequent engine crankcase oil leakage that cannot be stopped.

### SUMMARY OF THE INVENTION

The primary objective of the invention herein is to provide an improved structure automobile engine crankcase oil drain tap plug that not only automatically collects metal particles in engine crankcase oil, but at the same time also ensures the non-occurrence of engine crankcase oil leakage.

Another objective of the invention herein is to provide an improved structure automobile engine crankcase oil drain tap plug that adopts a graduated directive means to effectively prevent oil contamination and splattering situations, thereby ensuring work floor cleanliness.

Therefore, the improved structure automobile engine crankcase oil drain tap plug of the invention herein is comprised of a tap plug member, a guide sleeve, and a sealing ring, wherein:

The said tap plug member outer diameter includes a drive section that provides for turning by a manual wrench (or socket), the top and bottom ends of said drive section are radially reduced to respectively form an upper threaded tubular section that fastens into an automobile crankcase drain hole and a lower threaded tubular section suspended below, a guide passage is formed lengthwise through the said upper threaded tubular section and lower threaded tubular section and, furthermore, a one-way non-return approach valve member is movably disposed on the said guide passage that shuts the lower extent of the said passage; an annular magnet is positioned inside the top end of the said upper threaded tubular section and a plurality of through-holes are bored into the underlying edge of its bottom end and, as such, the metal particles suspended in the crankcase oil are automatically collected and full oil convergence is provided for in the upper threaded tubular section.

The said guide sleeve is a threaded tube of a predetermined length fastened onto the outer diameter of the said tap plug member lower threaded tubular section such that it travels a predetermined distance lengthwise during an oil drainage operation; a holding rod is trussed through the internal section and, furthermore, along the center of the said guide passage, enabling the gradual opening of the guide passage as the guide sleeve shifts lengthwise and synchronously upward against the underside of the said steel ball valve member, its bottom end movably disposed on an oil conduit of a certain length to draw off the oil discharged through the said guide passage.

The said sealing ring is a cap having a one-way opening, with internal threads tapped from the ends along the inner diameter and an anti-leak washer such it can be fastened to the bottom extent of the suspended said tap plug member lower threaded tubular section.

The said assemblage results in an automobile engine crankcase oil drain tap plug possessing the most outstanding operating capability.

To enable the examination a further understanding of the objectives, functions, and advantages of the invention herein, the brief description of the drawings below is followed by the detailed description of preferred embodiment.

### BRIEF DESCRIPTION OF THE DRAWINGS

FIG. 1 is a cross-sectional and orthographic drawing of a conventional oil drain hole tap plug structure FIG. 2 is an exploded drawing of the most preferred embodiment of the invention herein.

FIG. 3 is a cross-sectional drawing of the most preferred embodiment of the invention herein.

FIG. 4 is a cross-sectional drawing of most preferred embodiment of the invention herein that illustrates operation.

FIG. 5 is an orthographic drawing of the invention herein as utilized for draining oil from an automotive vehicle.

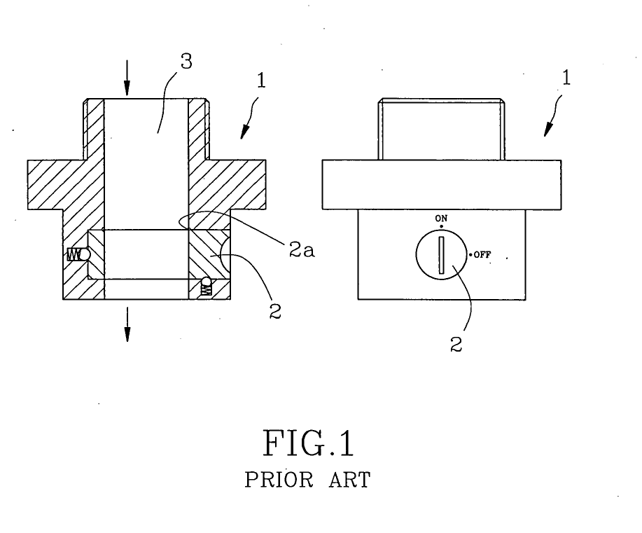

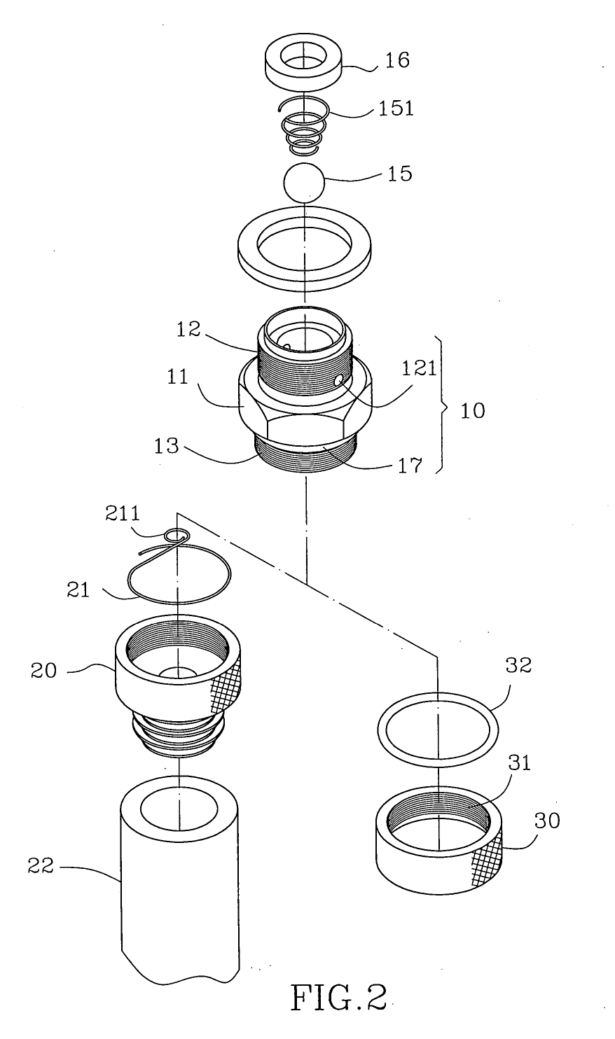

### DETAILED DESCRIPTION OF THE INVENTION

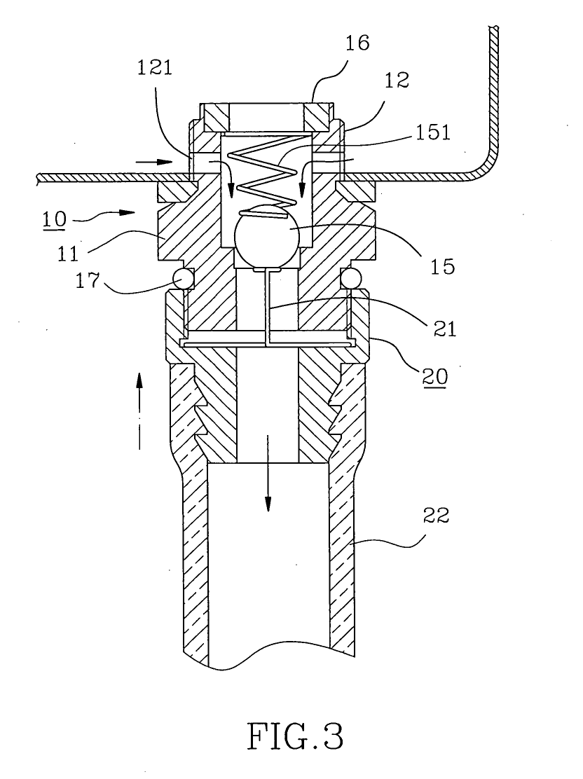

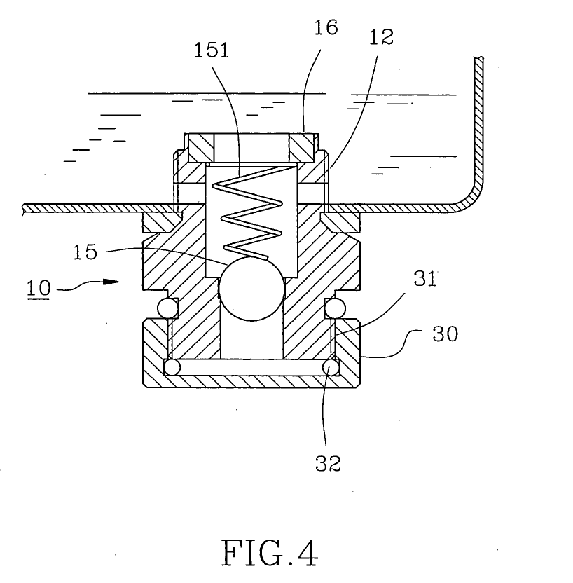

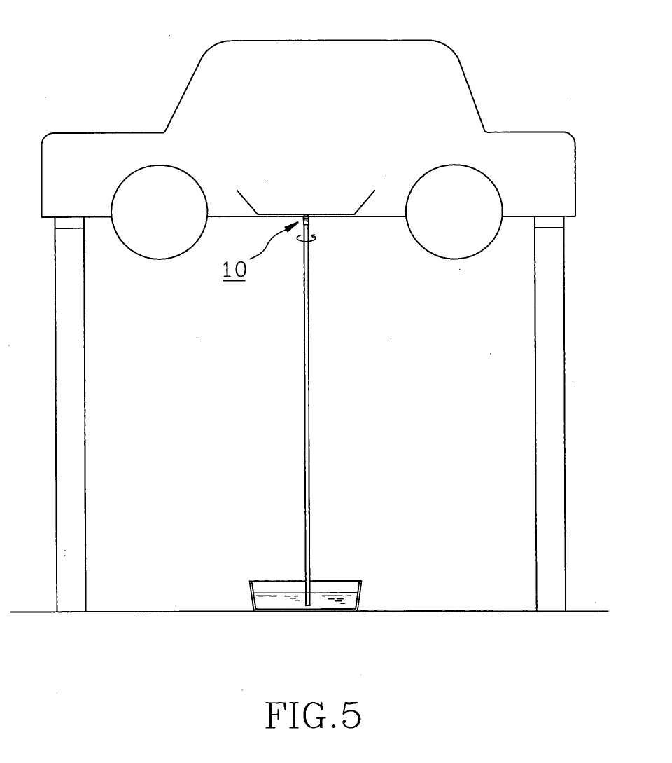

First, referring FIG. 2 and FIG. 3, the improved structure automobile engine crankcase oil drain tap plug of the invention herein is comprised of a tap plug member 10, a guide sleeve 20, and a sealing ring 30, wherein:

The said tap plug member 10 outer diameter includes a drive section 11 that provides for turning by a manual wrench (or socket), the top and bottom ends of said drive section 11 are radially reduced to respectively form an upper threaded tubular section 12 that fastens into an automobile crankcase drain hole and a lower threaded tubular section 13 suspended below, a guide passage 14 is formed lengthwise through the said upper threaded tubular section 12 and lower threaded tubular section 13 and, furthermore, a one-way non-return approach valve member 15 is movably disposed on the said guide passage 14 that shuts the lower extent of the said passage, the optimal choice for the valve member 15 in the embodiment herein is a steel ball, with a spring 151 over it which thereby ensures that the steel ball valve member 15 is brought upward to seal the said guide passage 14.

An annular magnet 16 is positioned inside the top end of the said upper threaded tubular section 12 and a plurality of through-holes 121 are bored into the underlying edge of its bottom end and, as such, the metal particles suspended in the crankcase oil are. automatically collected and full oil convergence is provided for in the upper threaded tubular section 12; an O-ring 17 is tightly ensleeved over the lower threaded tubular section 13 adjacent to the shoulder outer diameter of the said drive section 11, thereby preventing leakage and unscrewing as well as limiting the operational range of the movably positioned guide sleeve 20 (further elaborated below).

The said guide sleeve 20 is a threaded tube of a predetermined length fastened onto the outer diameter of the said tap plug member 10 lower threaded tubular section 13 such that it travels a predetermined distance lengthwise during an oil drainage operation; a holding rod 21 is trussed through the internal section and, furthermore, along the center of the said guide passage 14, in the embodiment herein a spring steel wire formed by bending spirally and concluding in a bearing section 211 at the top extremity, enabling the gradual opening of the guide passage 14 as the guide sleeve 20 shifts lengthwise and synchronously upward against the underside of the said steel ball valve member 15, its bottom end movably disposed on an oil conduit 22 of a certain length to draw off the oil discharged through the said guide passage 14.

The said sealing ring 30 is a cap having a one-way opening, with internal threads 31 tapped from the ends along the inner diameter and an anti-leak washer 32 such it can be fastened to the bottom extent of the suspended said tap plug member 10 lower threaded tubular section 13, the automobile engine crankcase thereby not requiring double leakage protection during oil drainage.

The said assemblage constitutes the improved structure automobile engine crankcase oil drain tap plug of the invention herein, the tap plug member 10 upper threaded tubular section 12 is ordinarily fastened to the automobile engine crankcase oil drain hole, wherein the steel ball valve member 15 on the guide passage 14 is axially impelled by the spring 151 above it such that the steel ball valve member 15 is brought downward to close the said guide passage 14, preventing the seepage of oil out of the engine crankcase, with the sealing ring 30 internal threads 31 and anti-leak washer 32 fastened to the said plug member 10 lower threaded tubular section 13; as such, with the internal imperviousness of the sealing ring 30, the automobile engine crankcase does not require double leakage protection during oil drainage.

During maintenance oil changes of the said automobile, the said sealing ring 30 fastened to the said plug member 10 lower threaded tubular section 13 is turned and loosened, following which the guide sleeve 20 fastened to the said plug member 10 lower threaded tubular section 13 is rotatively driven forward lengthwise along the plug member 10 lower threaded tubular section 13, synchronously shifting the holding rod 21 trussed in the center of the internal section towards the said guide passage 14, wherein the bearing section 211 at the top extremity of the holding rod 21 supporting the underside of the steel ball valve member 15 moves upward, incrementally raising the steel ball valve member 15 to open the said guide passage 14 and since the guide passage 14 is gradually opened, the used oil in the engine crankcase flows via the plurality of through-holes 121 bored in the upper threaded tubular section 12, rapidly converging into the upper threaded tubular section 12, with the oil-suspended metal particles automatically collected and separated by the magnetic lines of force from the annular magnet 16 positioned in the top end of the upper threaded tubular section 12, and when the guide sleeve 20 is rotatively advanced a lengthwise distance along the lower threaded tubular section 13 outer diameter to the position of the ensleeved O-ring 17, the steel ball valve member 15 is completely released by the said bearing section 211 from the closure position at the lower extent of the guide passage 14, allowing the rapid and guided discharge of the oil converging in the upper threaded tubular section 12 through the connected oil conduit 22; as a result, conventional oil contamination and splattering situations cannot occur, thereby ensuring work floor cleanliness.

In summation of the foregoing section, the technological concept and original spatial arrangement of the improved structure automobile engine crankcase oil drain tap plug of the invention herein not only automatically collects metal particles suspended in the engine crankcase oil, but at the same time also ensures the non-occurrence of engine crankcase oil leakage, adopting a graduated directive means to effectively prevent oil contamination and splattering situations and thereby ensure work floor cleanliness.

1. An improved structure automobile engine crankcase oil drain tap plug comprised of a tap plug member, a guide sleeve, and a sealing ring, wherein:
the said tap plug member outer diameter includes a drive section that provides for turning by a manual wrench (or socket), the top and bottom ends of said drive section are radially reduced to respectively form an upper threaded tubular section that fastens into an automobile crankcase drain hole and a lower threaded tubular section suspended below, a guide passage is formed lengthwise through the said upper threaded tubular section and the said lower threaded tubular section and, furthermore, a one-way non-return approach valve member is movably disposed on the said guide passage that shuts the said lower extent of the said passage; an annular magnet is positioned inside the top end of the said upper threaded tubular section and a plurality of through-holes are bored into the underlying edge of its bottom end and, as such, the metal particles suspended in the crankcase oil are automatically collected and full oil convergence is provided for in the said upper threaded tubular section;
the said guide sleeve is a threaded tube of a predetermined length fastened onto the outer diameter of the said tap plug member lower threaded tubular section such that it travels a predetermined distance lengthwise during an oil drainage operation; a holding rod is trussed through the internal section and, furthermore, along the center of the said guide passage, enabling the gradual opening of the said guide passage as the said guide sleeve shifts lengthwise and synchronously upward against the underside of the said valve member, its bottom end movably disposed on an oil conduit of a certain length to draw off the oil discharged through the said guide passage;
the said sealing ring is a cap having a one-way opening, with internal threads tapped from the ends along the inner diameter and an anti-leak washer such it can be fastened to the bottom extent of the suspended said tap plug member lower threaded tubular section, the automobile engine crankcase thereby not requiring double leakage protection during oil drainage. 2. As mentioned in claim 1 of the improved structure automobile engine crankcase oil drain tap plug of the invention herein, the said valve member on the said guide passage optimally consists of a steel ball with a spring movably disposed over it which thereby ensures that the said steel ball is brought downward to seal the said guide passage. 3. As mentioned in claim 1 of the improved structure automobile engine crankcase oil drain tap plug of the invention herein, the said holding rod trussed lengthwise through the internal section of the said guide passage has a bearing section at its top extremity which stably supports the underside of the said valve member.
